(19) United States
(12) Patent Application Publication
(10) Pub. No.: US 2011/0116228 A1
(43) Pub. Date: May 19, 2011

(54) Notebook computer having flexible mounting space for wireless communication module

(76) Inventors: Chien-Te Lee, Luzhou (TW); Ching-Chung Chiang, Wugu Township (TW)

(21) Appl. No.: 12/659,746

(22) Filed: Mar. 19, 2010

(30) Foreign Application Priority Data
Nov. 17, 2009 (CN) 200920174471.9

(51) Int. Cl. G06F 1/16

(52) U.S. Cl. 361/679.55

(57) ABSTRACT

A notebook computer having flexible mounting space for wireless communication module has a base, a display device and at least one wireless communication component set. The base has a motherboard. The display device is pivotally connected to the base and has a front cover, a display screen and a rear cover. The front cover is rectangular and has a side frame. The display screen is mounted inside the side frame. The rear cover is mounted on the front cover. The at least one wireless communication module is mounted on the side frame and between the front cover and the rear cover so as to reduce the overall size of the notebook computer. Moreover, the wireless communication component set can utilize a default antenna embedded in the notebook computer or an antenna embedded therein to further increase the available space, simplify operation and lower the cost of the notebook computer.

### BACKGROUND OF THE INVENTION

1. Field of the Invention

The present invention is related to a notebook computer, and more particularly to a notebook computer capable of allocating wireless communication module on a side frame of a display device of the notebook computer.

2. Description of the Related Art

For the sake of portability, miniaturization of notebook computers is important, so motherboards must also be minimized.

Wireless communication has been extensively and progressively developed in recent years. New communication protocols, such as bluetooth, WiFi, 802.11b/g/n, and the like, are continuously upgraded and delivered to market. Therefore, most notebook computers include a wireless communication module.

Accordingly, one or more wireless communication circuits need to be integrated onto a motherboard or at least one socket is reserved on the motherboard for connection of wireless communication modules. Therefore, a size of a base of a notebook computer must be increased to accommodate the wireless communication circuit or module. With reference to FIGS. 11 to 13, conventional notebook computer vendors insert wireless communication modules (72, 72′) on a motherboard (6). Antennae (71, 71′) are respectively mounted on two top corners of a side frame (54) of the LCD display screen (52). Antenna cables (73, 73′) electrically connect the wireless communication modules (72, 72′) on the motherboard (6) and the antennae (71, 71′). As the wireless communication modules (72, 72′) are mounted on the motherboard (6), precious space of the base of the notebook computer is occupied, thereby disadvantaging overall size reduction of notebook computers.

### SUMMARY OF THE INVENTION

An objective of the present invention is to provide a notebook computer allocating wireless communication module on a side frame of a display device of the notebook computer.

To achieve the foregoing objective, the notebook computer having flexible mounting space for wireless communication module has a base and a display device.

The base has a motherboard. The display device is pivotally connected to the base and has a front cover, a display screen and a rear cover. The front cover is rectangular and has a side frame. The display screen is mounted on the side frame. The rear cover is mounted on the front cover. The at least one wireless communication component set is mounted between the front cover and the rear cover and corresponds to the side frame.

Initially located on the motherboard in the base of the notebook computer, the wireless communication component set is allocated to the display device of the notebook computer. As the space on the motherboard is very limited, the allocation of the wireless communication component set facilitates development of other more critical components on the motherboard.

### BRIEF DESCRIPTION OF THE DRAWINGS

FIG. 1 is a front perspective view of a notebook computer in accordance with the present invention;

FIG. 2 is a front view of a first preferred embodiment of a display device having a wireless communication component set for a notebook computer in accordance with the present invention;

FIG. 3 is a front view of a second preferred embodiment of a display device having a wireless communication component set for a notebook computer in accordance with the present invention;

FIG. 4 is a front view of a third preferred embodiment of a display device having a wireless communication component set for a notebook computer in accordance with the present invention;

FIG. 5 is a front view of a fourth preferred embodiment of a display device having a wireless communication component set for a notebook computer in accordance with the present invention;

FIG. 6 is a front view of a fifth preferred embodiment of a display device having two wireless communication component sets for a notebook computer in accordance with the present invention;

FIG. 7 is a front view of a sixth preferred embodiment of a display device having two wireless communication component sets for a notebook computer in accordance with the present invention;

FIG. 8 is a front view of a seventh preferred embodiment of a display device having two wireless communication component sets for a notebook computer in accordance with the present invention;

FIG. 9 is a front view of a eighth preferred embodiment of a display device having two wireless communication component sets for a notebook computer in accordance with the present invention;

FIG. 10 is an enlarged and exploded perspective view of a wireless communication module fastening mechanism for a notebook computer in accordance with the present invention;

FIG. 11 is a front perspective view of a conventional notebook computer having two wireless communication component sets;

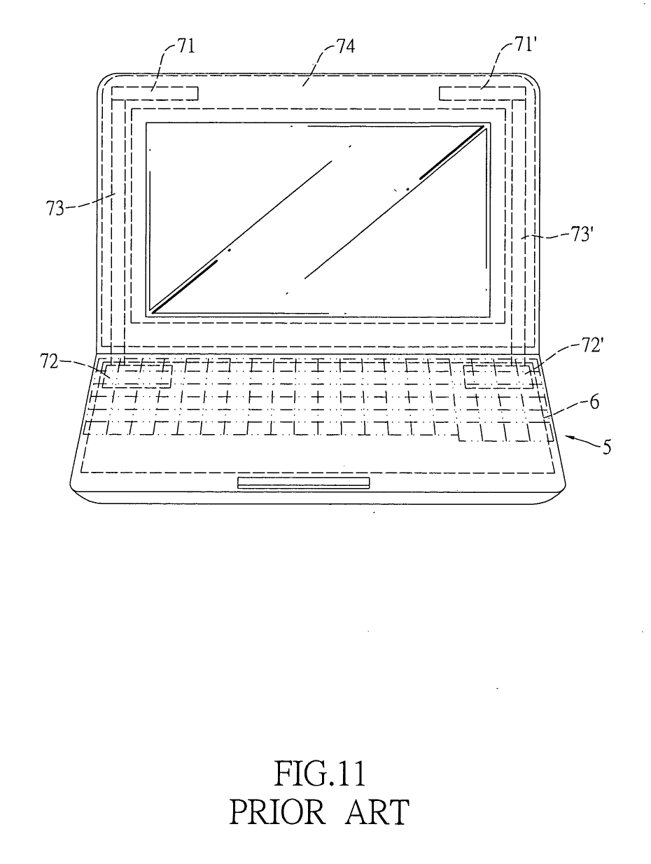

FIG. 12 is a top view of a conventional motherboard having two wireless communication component sets; and

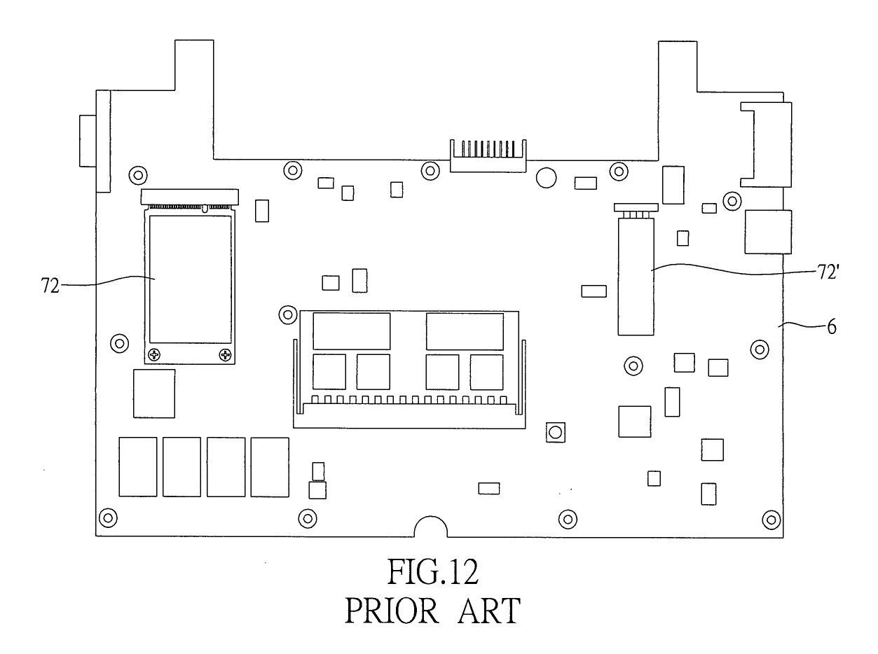

FIG. 13 is a side view of a conventional motherboard having a wireless communication component set.

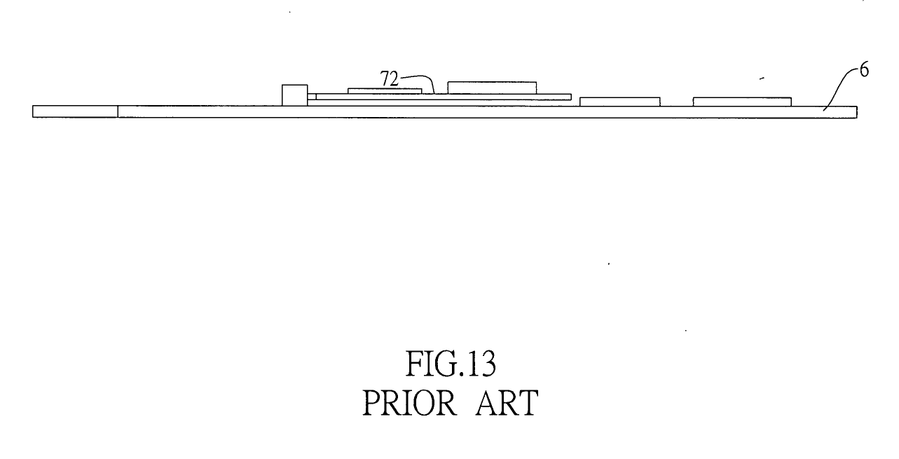

### DETAILED DESCRIPTION OF THE INVENTION

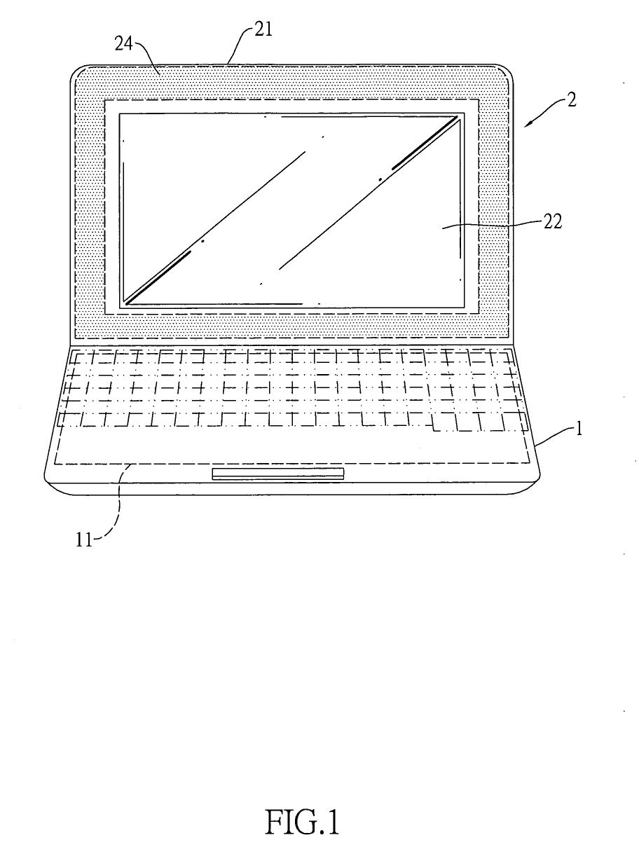

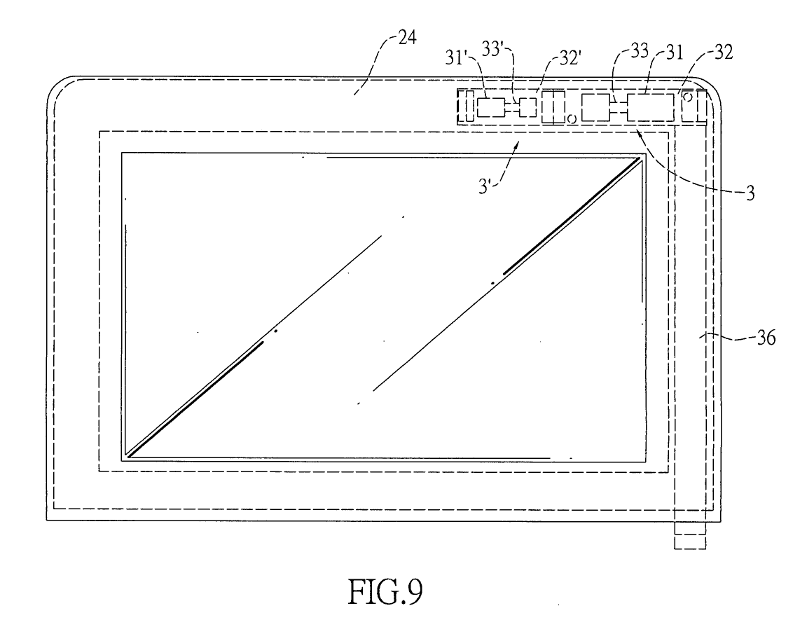

With reference to FIGS. 1 and 9, a notebook computer having flexible mounting space for wireless communication module in accordance with the present invention has a base (1), a display device (2) and at least one wireless communication component set selectively mounted on a shaded area.

The base (1) has a motherboard (11). The display device (2) is pivotally connected to the base (1) and has a front cover (21), a LCD display screen (22) and a rear cover (23). The rear cover (23) is rectangular and has a side frame (24). The LCD display screen (22) is mounted on the side frame (24). The rear cover (23) corresponds to the front cover (21) and is mounted thereon. The at least one wireless communication component set is mounted between the front cover (21) and the rear cover (23) and within the side frame (24).

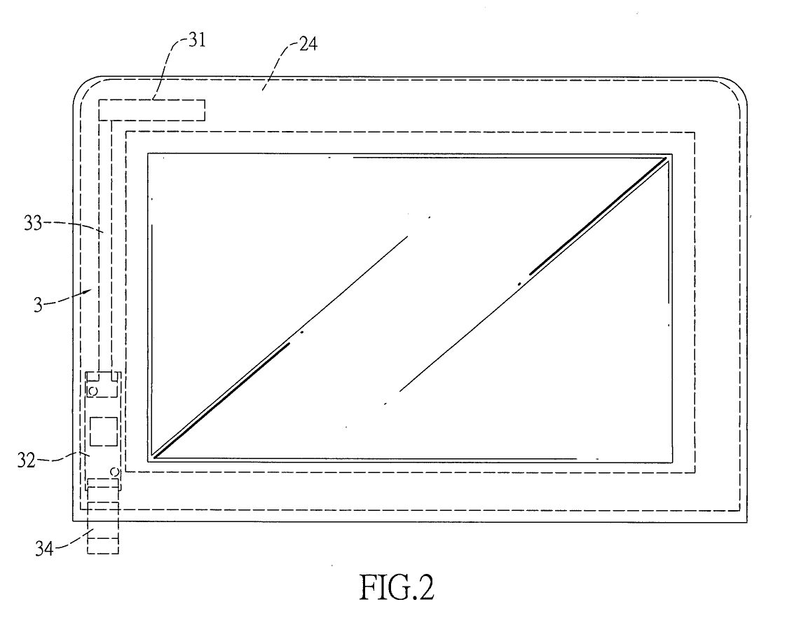

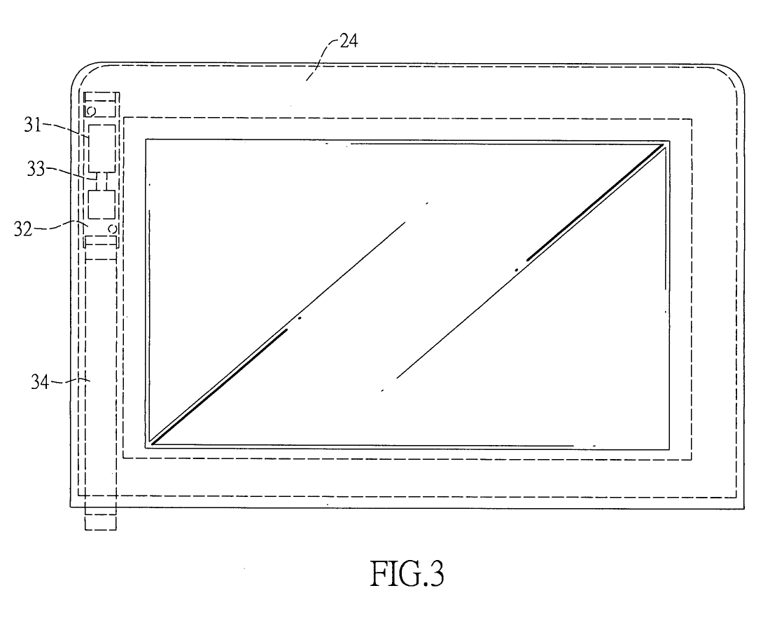

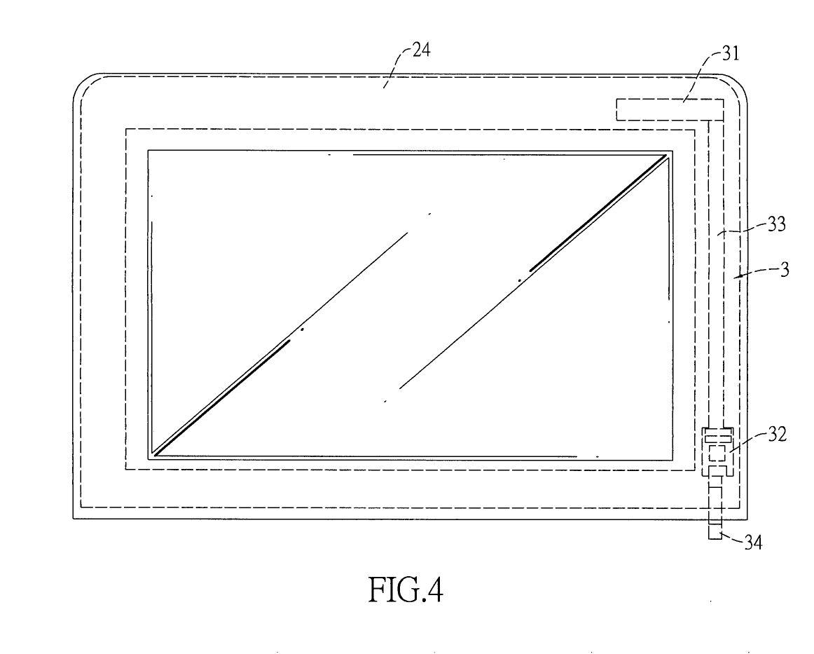

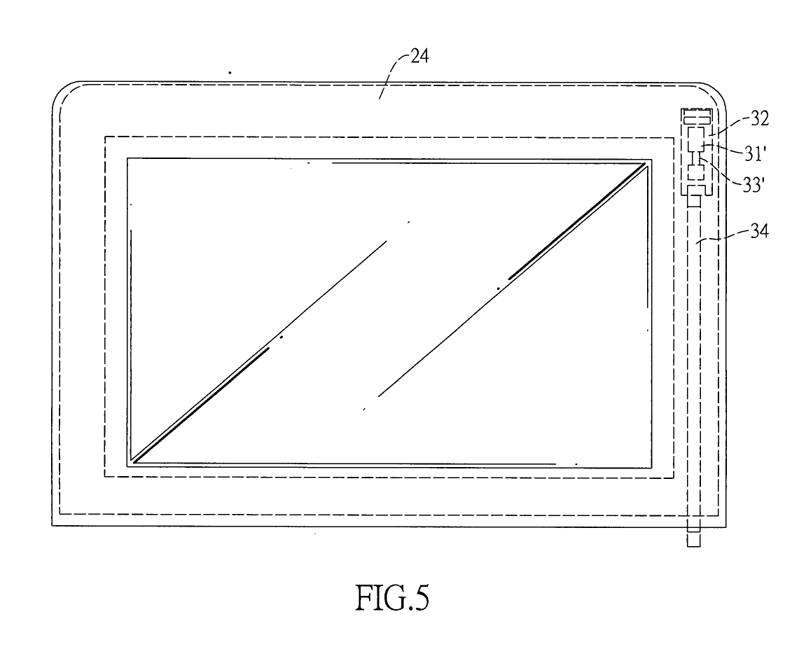

With further reference to FIGS. 2 to 5, a first to fourth embodiments of a notebook computer having a wireless communication component set in accordance with the present invention are shown. The wireless communication component set (3) in FIG. 2 has an antenna (31), a wireless communication module (32), an antenna connection cable (33) and a system connection cable (34). The antenna (31) is embedded in the display device (2) of the notebook computer. The wireless communication component set (3) is also embedded in the display device (2). The antenna connection cable (33) is mounted between and electrically connected with the antenna (31) and the wireless communication module (32). The system connection cable (34) is mounted between the wireless communication module (32) and the motherboard (11).

The antenna (31) may be mounted on a top left corner of the side frame (24), and the wireless communication module (32) is mounted on a corner of the side frame (24) directly under the antenna (31). Alternatively, the antenna (31) may be mounted on a top right corner of the side frame (24), and the wireless communication module (32) is mounted on a corner of the side frame (24) directly under the antenna (31).

The antenna (31) and the antenna connection cable (33) may be also embedded in the wireless communication module (32), and the antenna connection cable (33) is electrically connected with the wireless communication module (32) through the antenna connection cable (33). The antenna connection cable (33) may be in a form of a circuit. The wireless communication module (32) is mounted on a top left corner of the side frame (24). Alternatively, the wireless communication module (32) is mounted on a top right corner of the side frame (24). The wireless communication module (32) is electrically connected with the motherboard (11) through the system connection cable (34).

In the first to fourth embodiments, the wireless communication module (32) may be a wireless local area network (WLAN) module or a bluetooth wireless communication module.

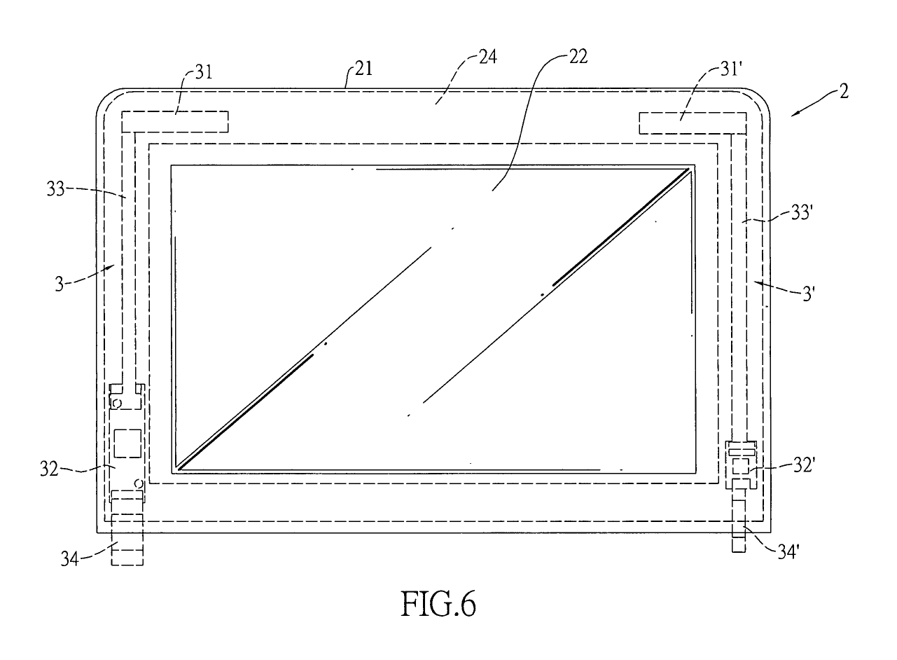

With further reference to FIGS. 6 to 9, a fifth to eighth embodiments of a notebook computer having two wireless communication component sets (3, 3′) in accordance with the present invention are shown. With reference to FIG. 6, each of the two wireless communication modules (3, 3′) has an antenna (31, 31′), a wireless communication module (32, 32′), an antenna connection cable (33, 33′) and a system connection cable (34, 34′). The antenna connection cable (33, 33′) is mounted between and electrically connected with the antenna (31, 32′) and the wireless communication module (32, 32′). The system connection cable (34, 34′) is mounted between and electrically connected with the wireless communication modules (32, 32′) and the motherboard (11). The antenna (31, 31′) is embedded in the display device (2) of the notebook computer. The antenna (31, 31′) may be mounted on a top left corner or a top right corner of the side frame (24), and the wireless communication module (32) is mounted on a corner of the side frame (24) directly under the antenna (31).

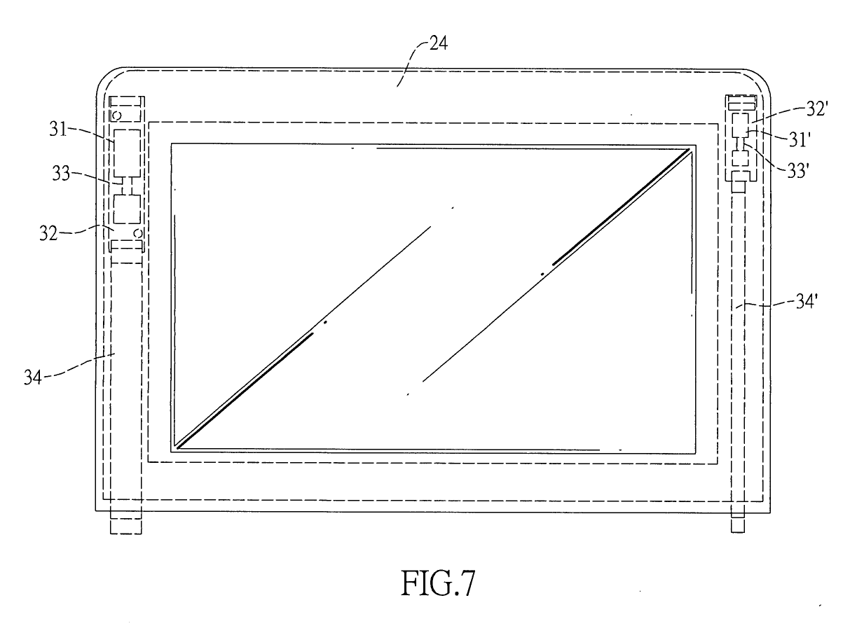

With reference to FIG. 7, one antenna (31) and the corresponding antenna connection cable (33) may be embedded in the wireless communication module (32), and the wireless communication module (32) is mounted on a top left corner of the side frame (24). The wireless communication module (32) is electrically connected with the motherboard (11) through the system connection cable (34). The other antenna (31′) and the corresponding antenna connection cable (33′) may be also embedded in the corresponding wireless communication module (32′), and the wireless communication module (32′) is mounted on a top right corner of the side frame (24). The wireless communication module (32′) is electrically connected with the motherboard (11) through the system connection cable (34′). The antenna connection cable (33, 33′) may be in a form of a circuit.

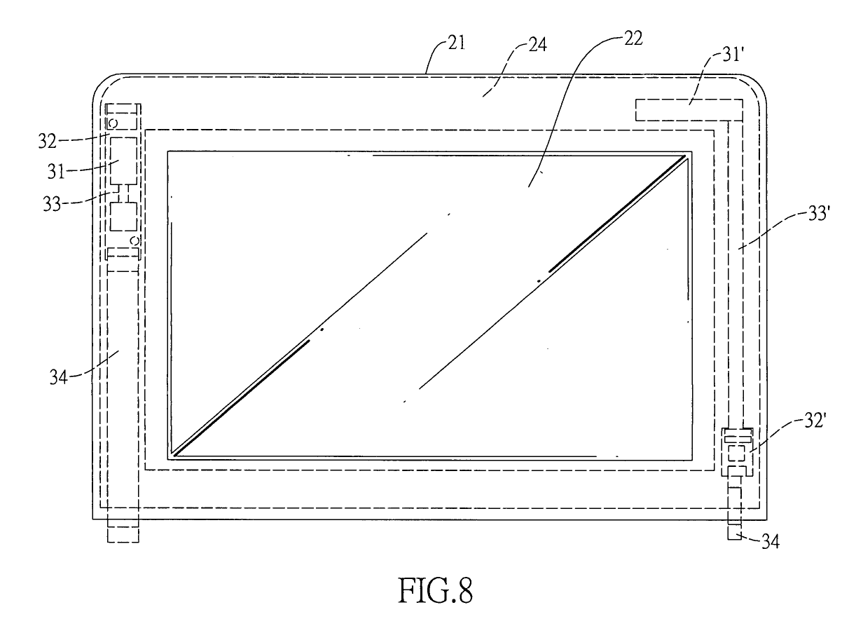

With reference to FIG. 8, one antenna (31) and the corresponding antenna connection cable (33) may be embedded in the corresponding wireless communication module (32), and the wireless communication module (32) is mounted on a top left corner of the side frame (24). The wireless communication module (32) is electrically connected with the motherboard (11) through the system connection cable (34). The other antenna (31′), the other wireless communication module (32′) and the other antenna connection cable (33′) are independently separated. The antenna connection cable (33′) is mounted between and electrically connected with the antenna (31′) and the wireless communication module (32′). The system connection cable (34′) is mounted between and electrically connected with the wireless communication module (32′) and the motherboard.

With reference to FIG. 9, a seventh embodiment of a notebook computer having two wireless communication component sets (3, 3′) in accordance with the present invention is shown. Each of the wireless communication component sets (3, 3′) has a wireless communication module (32, 32′) and a common system connection cable (36). One wireless communication module (32) is embedded with an antenna (31) and an antenna connection cable (33), and the other wireless communication module (32′) is also embedded with an antenna (32′) and an antenna connection cable (33′). The antenna connection cable (33, 33′) may be in a form of a circuit. The common system connection cable (36) is mounted between and electrically connected with the two wireless communication modules (32, 32′) and the motherboard (11).

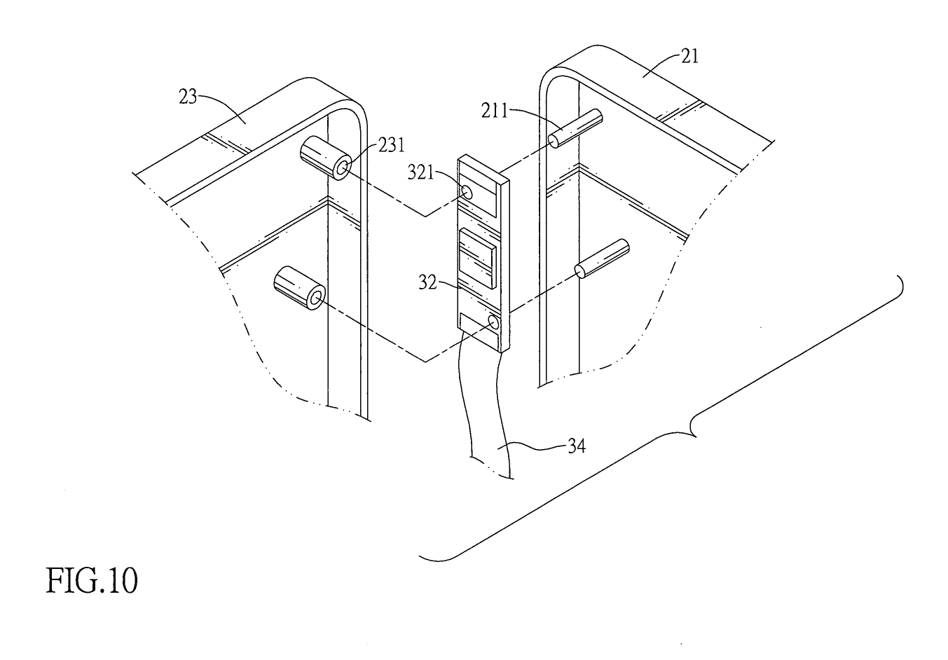

With reference to FIG. 10, the wireless communication module (32) has at least two through holes (321) located on a top portion and a bottom portion thereof. At least two pairs of pins (211) and pin holes (231) are respectively mounted on the front cover (21) and the rear cover (23) to correspond to the two through holes (321). When the front cover (21) is connected with the rear cover (23), the pins (211) respectively pass through the corresponding through holes and insert in the corresponding pin holes (231) so as to fasten the wireless communication module (32) between the front cover (21) and the rear cover (23).

To maintain good wireless reception and transmission, the antenna is preferably mounted at a higher position. In the present invention, a top portion of the side frame (24) is considered to be an ideal portion to mount the antenna.

The wireless communication module initially located in the motherboard of the notebook computer is allocated to the side frame of the display device of the notebook computer so as to free up space in the base of the notebook computer and facilitate further miniaturization of the notebook computer. As the wireless communication module can utilize the default antenna in the notebook computer or its embedded antenna, development and production of motherboard and wireless communication module can be more flexible. Furthermore, the antenna and the wireless communication module can be integrated so as to address more available space, simplified operation and overall cost down of notebook computers.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A notebook computer having flexible mounting space for wireless communication module, comprising:
a base comprising a motherboard; and
a display device pivotally connected to the base and having
a front cover being rectangular and having a side frame;
a display screen mounted on the side frame;
a rear cover mounted on the front cover; and
at least one wireless communication component set mounted between the front cover and the rear cover and corresponding to the side frame.

2. The notebook computer as claimed in claim 1, wherein the at least one wireless communication component set comprises:
an antenna mounted on a top edge of the side frame; and
a wireless communication module electrically connected with the antenna through an antenna connection cable, and electrically connected with the motherboard through a system connection cable.

3. The notebook computer as claimed in claim 2, wherein
the antenna and the antenna connection cable are embedded in the wireless communication module; and
the wireless communication module is mounted on the top edge of the side frame.

4. The notebook computer as claimed in claim 2, wherein the wireless communication module is a WLAN module.

5. The notebook computer as claimed in claim 3, wherein the wireless communication module is a WLAN module.

6. The notebook computer as claimed in claim 2, wherein the wireless communication module is a bluetooth wireless communication module.

7. The notebook computer as claimed in claim 3, wherein the wireless communication module is a bluetooth wireless communication module.

8. The notebook computer as claimed in claim 1 comprising two wireless communication component sets, each having
an antenna mounted on a top edge of the side frame; and
a wireless communication module electrically connected with the antenna and electrically connected with the motherboard through a system connection cable.

9. The notebook computer as claimed in claim 8, wherein
the antenna and the antenna connection cable of one wireless communication component set are embedded in the wireless communication module and the wireless communication module is mounted on a top edge of the side frame; and
the antenna of the other wireless communication component set is mounted on the top edge of the side frame.

10. The notebook computer as claimed in claim 8, wherein
the antenna and the antenna connection cable of one wireless communication component set are embedded in the wireless communication module and the wireless communication module is mounted on a top edge of the side frame; and
the antenna and the antenna connection cable of the other wireless communication component set are embedded in the wireless communication module and the wireless communication module is mounted on a top edge of the side frame.

11. The notebook computer as claimed in claim 1 comprising two wireless communication component sets, each having
an antenna; and
a wireless communication module electrically connected with the antenna through an antenna connection cable;
wherein the antenna of each wireless communication component set and the corresponding antenna connection cable are embedded in the corresponding wireless communication component set, the two wireless communication component sets are mounted on a top edge of the side frame and are electronically connected with the motherboard through a common system connection cable.

12. The notebook computer as claimed in claim 8, wherein one of the two wireless communication component sets is a WLAN module and the other wireless communication component set is a bluetooth wireless communication module.

13. The notebook computer as claimed in claim 9, wherein one of the two wireless communication component sets is a WLAN module and the other wireless communication component set is a bluetooth wireless communication module.

14. The notebook computer as claimed in claim 10, wherein one of the two wireless communication component sets is a WLAN module and the other wireless communication component set is a bluetooth wireless communication module.

15. The notebook computer as claimed in claim 11, wherein one of the two wireless communication component sets is a WLAN module and the other wireless communication component set is a bluetooth wireless communication module.

16. The notebook computer as claimed in claim 2, wherein each of the at least one wireless communication component set has at least two through holes respectively located at a top portion and a bottom portion thereof, at least two pairs of pins and pinholes are respectively formed on the front cover and the rear cover to correspond to the at least two through holes so that the at least two pins respectively pass through the at least two through holes and respectively insert in the at least two pinholes to fasten the at least one wireless communication component set between the front cover and the rear cover when the front cover and the rear cover are connected.

17. The notebook computer as claimed in claim 3, wherein each of the at least one wireless communication component set has at least two through holes respectively located at a top portion and a bottom portion thereof, at least two pairs of pins and pinholes are respectively formed on the front cover and the rear cover to correspond to the at least two through holes so that the at least two pins respectively pass through the at least two through holes and respectively insert in the at least two pinholes to fasten the at least one wireless communication component set between the front cover and the rear cover when the front cover and the rear cover are connected.

18. The notebook computer as claimed in claim 8, wherein each wireless communication component set has at least two through holes respectively located at a top portion and a bottom portion thereof, at least four pairs of pins and pinholes are respectively formed on the front cover and the rear cover to correspond to the at least four through holes so that the at least four pins respectively pass through the at least four through holes and respectively insert in the at least four pinholes to fasten the two wireless communication component sets between the front cover and the rear cover when the front cover and the rear cover are connected.

19. The notebook computer as claimed in claim 9, wherein each wireless communication component set has at least two through holes respectively located at a top portion and a bottom portion thereof, at least four pairs of pins and pinholes are respectively formed on the front cover and the rear cover to correspond to the at least four through holes so that the at least four pins respectively pass through the at least four through holes and respectively insert in the at least four pinholes to fasten the two wireless communication component sets between the front cover and the rear cover when the front cover and the rear cover are connected.

20. The notebook computer as claimed in claim 10, wherein each wireless communication component set has at least two through holes respectively located at a top portion and a bottom portion thereof, at least four pairs of pins and pinholes are respectively formed on the front cover and the rear cover to correspond to the at least four through holes so that the at least four pins respectively pass through the at least four through holes and respectively insert in the at least four pinholes to fasten the two wireless communication component sets between the front cover and the rear cover when the front cover and the rear cover are connected.

21. The notebook computer as claimed in claim 11, wherein each wireless communication component set has at least two through holes respectively located at a top portion and a bottom portion thereof, at least four pairs of pins and pinholes are respectively formed on the front cover and the rear cover to correspond to the at least four through holes so that the at least four pins respectively pass through the at least four through holes and respectively insert in the at least four pinholes to fasten the two wireless communication component sets between the front cover and the rear cover when the front cover and the rear cover are connected.
